(19) United States
(12) Patent Application Publication
(10) Pub. No.: US 2006/0116110 A1
(43) Pub. Date: Jun. 1, 2006

(54) Wireless connection method and system

(75) Inventors: Yu-Fang Chen, Taipei City (TW); Yi-Hao Chang, Yonghe City (TW); Kun-Chan Tsai, Shueishang Township (TW); Chih-Wei Su, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/028,567

(22) Filed: Jan. 5, 2005

(30) Foreign Application Priority Data
Nov. 26, 2004 (TW) 093136495

(51) Int. Cl. H04Q 7/20

(52) U.S. Cl. 455/412.2

(57) ABSTRACT

A wireless connection method and system controlled by the callee device. The method of the present invention comprises: a connection request step, a paging step, a paging message reception step, a connection creation step, and a call notification step, so the callee device can provide a notification to a user before a connection is built; if the user refuses the call, the connection will not be built; if the user answer the call, this connection can be built.

### BACKGROUND OF THE INVENTION

1. Field of the Invention

The present invention relates to a wireless connection method and system and, more particularly, to a wireless connection method and system controlled by the callee device.

2. Description of the Related Art

Mobile communication devices, such as second/third generation mobile telephones, personal handy-phone systems (PHS), etc. have achieved importance in modem life. The development trends in this industry are to reduce the size of devices, to add more functions in devices, and to increase the standby time. Before the breaking technologies in the field of battery material are introduced, the best way to extend the period of standby time is to reduce the power consumption of the device.

Please refer to FIG. 1A and FIG. 1B. FIG. 1A illustrates the scenario in which a connection request is rejected according to a prior art. FIG. 1B illustrates the scenario in which a connection request is accepted according to the prior art. As shown in FIG. 1A, a caller device 11 seeks to set up an end-to-end service with a callee device 12. The caller device 11 sends a connection request 201 to a network 10. The network 10 then broadcasts a paging message 202; the paging message 202 includes an identification code of the callee device 12. The callee device 12 comprises a wireless transceiver module 120, communication software 121, and a man-machine interface 122. The wireless transceiver module 120 receives the paging message 202 from the network 10 and passes it to the communication software 121 for the later to determine whether the identification code in the paging message 202 matches the identification code of the callee device 12. If they match, the communication software 121 uses the wireless transceiver module 120 to establish a signaling connection with the network 10 and exchanges control commands with the network 10 via this signaling connection to set up the end-to-end service. After that, the communication software 121 sends the telephone number of the caller device 11 (if it is included in the paging message 202) to the man-machine interface 122 and request the later to provide the user 14 a notification of incoming call.

The above-mentioned operating procedure is performed whether the user 14 answers the call or not. If the user 14 answers the call, as shown in FIG. 1B, the caller 13 and the callee 14 can start to use the end-to-end service. However, if the user 14 misses the notification or refuse to answer (for example, the user may be in a meeting or a movie), the communication software 121 exchanges control command with the network 10 again to release the end-to-end service and the signaling connection, as shown in FIG. 1A. This wastes the power consumed for transmitting, receiving, and processing the control command, and consequently shortens the standby time of the device.

Therefore, it is desirable to provide a wireless connection method and system controlled by a callee device to mitigate and/or obviate the aforementioned problems.

### SUMMARY OF THE INVENTION

The present invention provides a wireless connection method and system controlled by the callee device. The method of the present invention comprises: a connection request step, a paging step, a paging message reception step, a connection creation step, and a call notification step. The system of the present invention includes a callee device, a caller device and a network. The network receives the connection request from the caller device and then broadcast a paging message; the paging message includes the identification code of the callee device. Every callee device within the range of broadcasting receives the paging message and compares the identification code included in the paging message with the identification code of the callee device; if they match, a call notification is provided on the callee device. If the user doesn't answer or refuse to answer the call, the callee device stops providing the call notification after waiting for a predetermined time. When the network fails to receive a connection request sent by the callee device after waiting for another predetermined time, it automatically executes the unanswered call processing procedure, which can include entering the callee's voice mailbox, directly stopping this call, or executing other similar procedures. By doing so, the callee device can avoid wasting power for connection establishment and the network can prevent from bandwidth consuming. Therefore, the present invention saves the related resources when the connection request is denied by the callee.

When the user answers the call within the first predetermined time, the callee device sends the connection request to network for establishment of the end-to-end service with the caller device.

The paging message sent by the network further includes a source number of the caller device, such as a telephone number, an identification code used to identify the caller, etc. The callee device can thus show the source number of the caller device to the user along with the call notification.

The present invention can be used in different wireless communication systems that employ different communication protocols, such as GSM systems, GPRS systems, third generation mobile communication systems (such as WCDMA and CDMA2000), etc.

Other objects, advantages, and novel features of the invention will become more apparent from the following detailed description when taken in conjunction with the accompanying drawings.

### BRIEF DESCRIPTION OF THE DRAWINGS

FIG. 1A is a schematic drawing showing refusal of a connection according to a prior art.

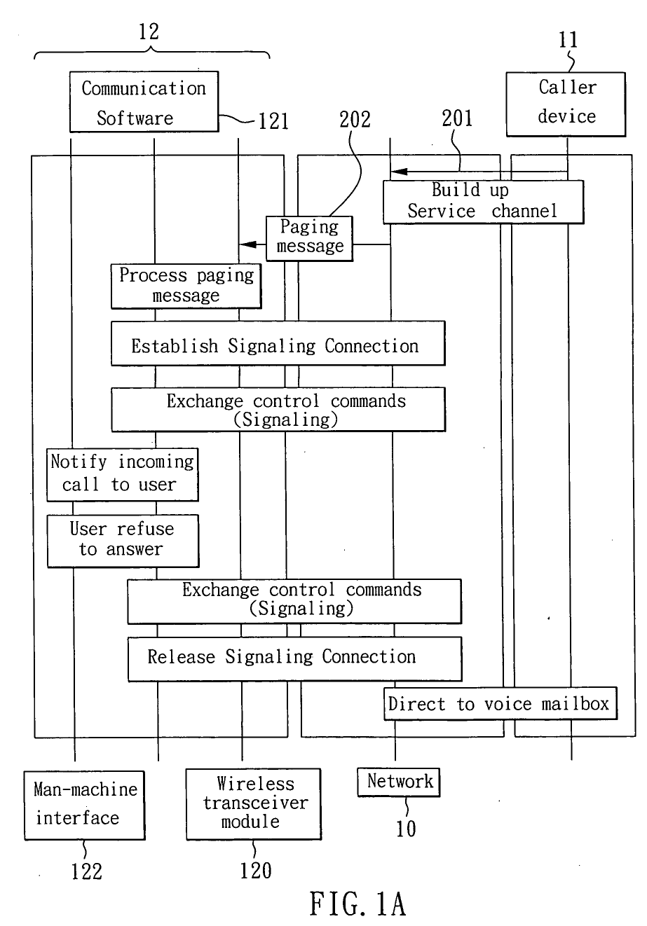

FIG. 1B is a schematic drawing showing acceptance of a connection according to the prior art.

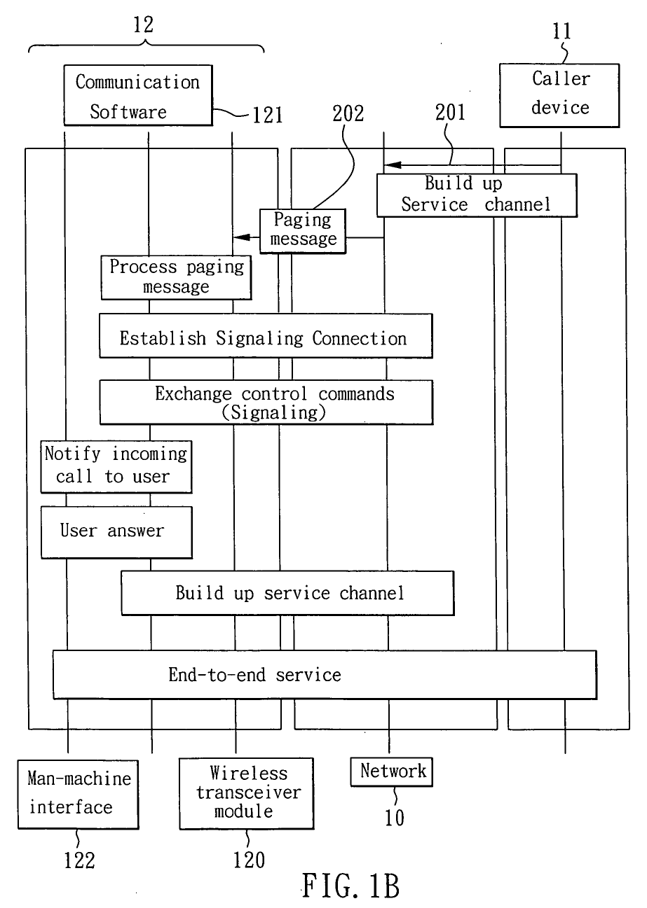

FIG. 2 is a system schematic drawing according to an embodiment of the present invention.

FIG. 3 is a flowchart of the embodiment of the present invention.

FIG. 4 is a schematic drawing of refusing a connection according to the embodiment of the present invention.

FIG. 5 is a schematic drawing of accepting a connection according to the embodiment of the present invention.

### DETAILED DESCRIPTION OF THE PREFERRED EMBODIMENT

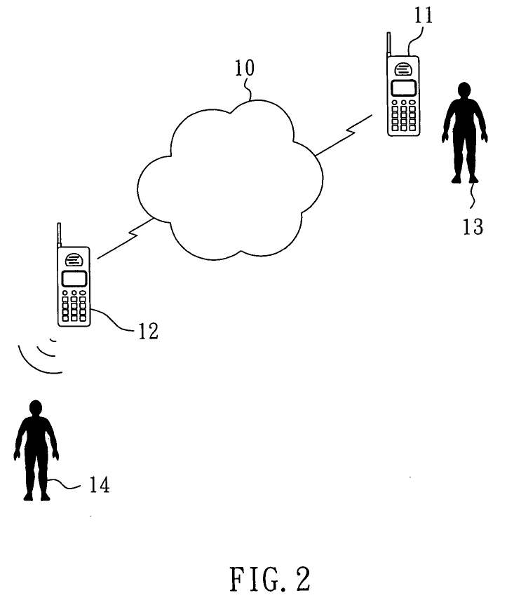

FIG. 2 is a system schematic drawing according an embodiment of the present invention. A caller 13 wishes to call a user 14 via a caller device 11; the caller device 11 is connected to the network 10, and the network 10 is connected to the callee device 12. The callee device 12 receives a paging message from the network 10. The paging message includes an identification code, and the callee device 12 compares the identification code in the paging message with its own identification code; if they are the same, the callee device presents a call notification to the user 14. In this embodiment, the communication environment is a wireless environment; the caller device 11 and the callee device 12 are both mobile telephones, and the network 10 is a wireless communication network.

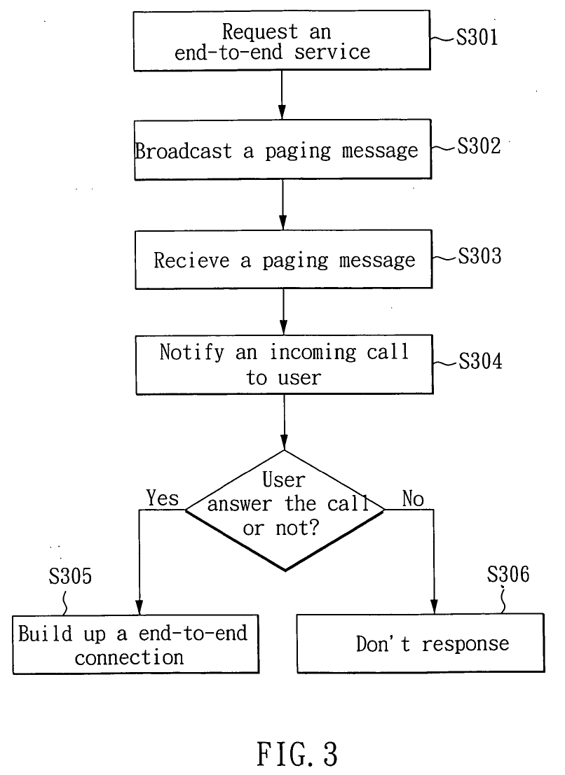

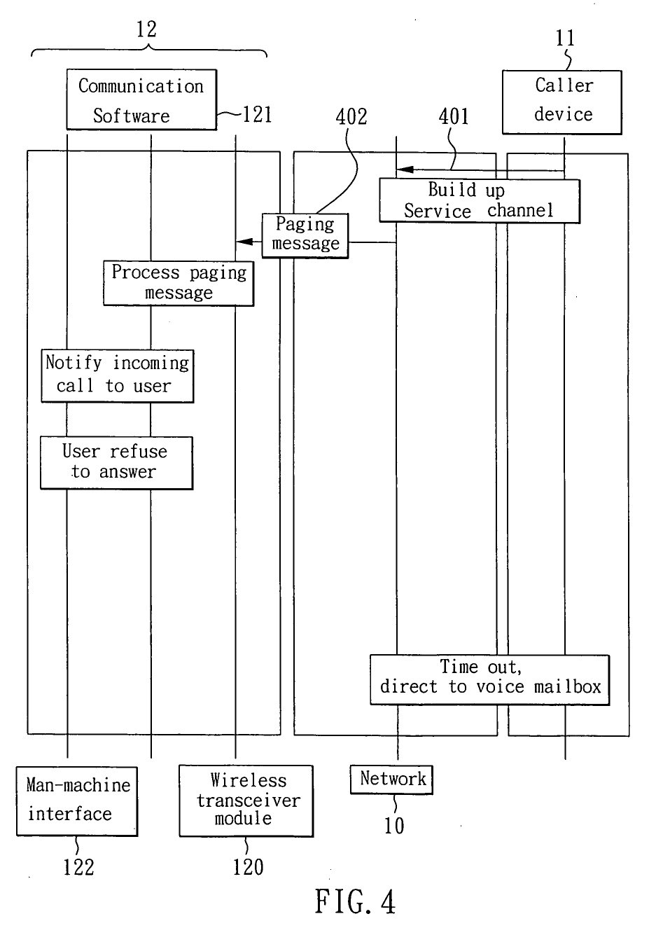

FIG. 3 is a flowchart of the embodiment of the present invention. A method of the present invention comprises: a connection request step (S301), a paging step (S302), a paging message reception step (S303), a call notification step (S304), and a connection creation step (S305). Please refer to FIG. 4. The caller device 11 sends out a connection request message 401 to request an end-to-end service to one callee device 12 (S301). The connection request message 401 includes a destination number to the callee device 12. After receiving the connection request message 401, the network 10 builds up a service channel with the caller device 11 and broadcasts a paging message 402 that includes the identification code of the callee device 12 to the area where the callee device 12 is located (S302).

When a wireless transceiver module 120 of the callee device 12 receives the paging message 402 (S303) and passes it to communication software 121, the communication software 121 compares the identification code in the paging message 402 with its own identification code; if they are the same, the communication software 121 notifies this incoming call to the user and requests a man-machine interface 122 to provide a call notification to the user 14 (S304). Finally, if the user 14 answers the call within a predetermined time (which may be configured by the system or the user), the callee device 12 sends out a connection creation response to build an end-to-end service to the caller device 11 via the network 10 (S305); otherwise the callee does not response (S306).

The callee device 12 provides the call notification and starts a timer to measure the elapsed waiting time; the network 10 also starts to count the elapsed time after broadcasting the paging message 402. If the user 14 does not answer the call within the predetermined time, the callee device 12 stops providing the call notification. If the user 14 refuses to answer and rejects the call manually, the callee device 12 also stops providing the call notification.

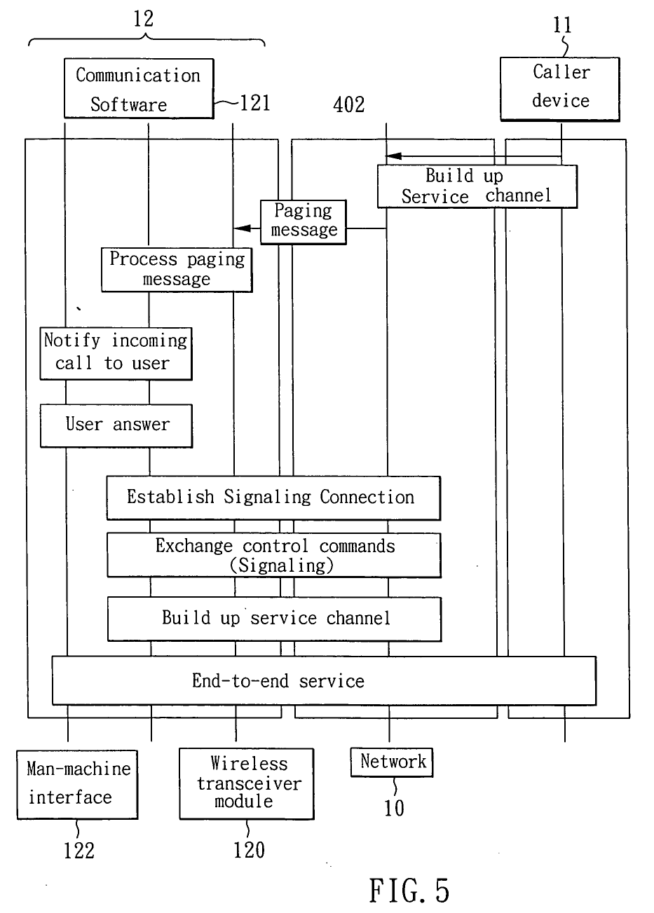

On the other hand, if the user 14 answers the call, as shown in FIG. 5, the communication software 121 creates the connection with the network 10 via the wireless transceiver module 120, and builds an end-to-end service with the caller device 11.

In order to enable the user 14 to recognize the caller device 11, the paging message 402 broadcasted by the network 10 further comprises the source number of the caller device 11, such as the telephone number, so that the man-machine interface 122 of the callee device 12 may inform the user 14 immediately.

Although the present invention has been explained in relation to its preferred embodiment, it is to be understood that many other possible modifications and variations can be made without departing from the spirit and scope of the invention as hereinafter claimed.

What is claimed is:

1. A wireless connection method for a callee device to create a connection requested by a caller device via a network, every callee device having an identification code, the method comprising:
a connection request step in which the caller device sends a connection request to the network to request a end-to-end service with the callee device;
a paging step in which the network broadcasts a paging message according to the connection request, wherein the paging message includes the identification code of the callee device;
a paging message reception step in which the callee device receives the paging message; and
a notification step in which the callee device compares the identification code of the paging message with the identification code of the callee device, and provides a call notification if they match.

2. The method as claimed in claim 1 further comprising:
a timing step for calculating the waiting time; and
a connection creation step in which when the waiting time is shorter than a first predetermined time and a user of the callee device decides to answer the call, the callee device sends a connection request to network and establishes the end-to-end service with the caller device.

3. The method as claimed in claim 2 further comprising:
a notice termination step in which when the waiting time is longer than the first predetermined time, the callee device stops providing the call notification.

4. The method as claimed in claim 2 further comprising:
an overtime determination step in which when the network sends the paging message and an elapsed time waiting for the connection request from the callee exceeds a second predetermined time, the network executes an unanswered call processing procedure.

5. The method as claimed in claim 4, wherein the unanswered call processing procedure comprises entering the callee's voice mailbox.

6. The method as claimed in claim 1, wherein in the paging step, the paging message sent from the network further includes a source number of the caller device.

7. The method as claimed in claim 6, wherein the source number of the caller device is a telephone number.

8. The method as claimed in claim 6, wherein in the notification step, the notification includes the source number of the caller device.

9. A wireless connection system controlled by the callee device comprising:
at least one callee device, every callee device having an identification code;
at least one caller device capable of sending at least one connection request to request an end-to-end service with the callee device; and
a network capable of receiving the connection request from the caller and broadcasting a paging message which includes the identification code of the callee device;
wherein every callee device is capable of receiving the paging message and comparing the identification code included in the paging message with the identification code of the callee device, and providing a notification on the callee device if the identification codes match.

10. The wireless connection system controlled by the callee device as claimed in claim 9, wherein the at least one callee device includes a wireless transceiver module for receiving the paging message broadcasted by the network and a communication software for comparing the identification code included in the paging message with the identification code of the callee device; if the identification codes match, the communication software requests the man-machine interface of the callee device to provide a notification.

11. The wireless connection system controlled by the callee device as claimed in claim 9, wherein the network receives the connection request sent by the caller device and broadcasts the paging message.

12. The wireless connection system controlled by the callee device as claimed in claim 9, wherein the callee device further comprises a timing mechanism to calculate the waiting time.

13. The wireless connection system controlled by the callee device as claimed in claim 12, wherein when the waiting time is shorter than a predetermined time and the user of the callee device answers the call, the callee device sends a connection request to network and establishes the end-to-end service with the caller device.

14. The wireless connection system controlled by the callee device as claimed in claim 12, wherein when the waiting time is longer than a predetermined time, the callee device stops providing the notification.

15. The wireless connection system controlled by the callee device as claimed in claim 9, wherein the paging message sent by the network further comprises the source number of the caller device.
